(19) United States
(12) Patent Application Publication
(10) Pub. No.: US 2021/0270525 A1
(43) Pub. Date: Sep. 2, 2021

(54) LIQUEFIED NATURAL GAS RECONDENSATION SYSTEM AND RELATED METHODOLOGY

(71) Applicant: IMI Japan KK, Hyogo (JP)

(72) Inventors: Yasuo Kobayashi, Hyogo (JP); Michael Wong, Hyogo (SG); JongWhoon Park, Hyogo (KR); Michael He, Hyogo (CN); Chethan Ghotekar, Hyogo (SG); Yoshihiro Maeda, (US); Liming Zhang, (US)

(21) Appl. No.: 16/804,991

(22) Filed: Feb. 28, 2020

(51) Int. Cl. F25J 3/06

(52) U.S. Cl. CPC F25J 3/0615; F25J 2205/90; F25J 2230/32; F25J 2210/90; F25J 2210/62; F25J 2205/04

(57) ABSTRACT

A method of recondensing boil off gas includes receiving liquefied natural gas from a storage tank and increasing the pressure of the received liquefied natural gas to produce increased pressure liquefied natural gas. The method further includes receiving boil off gas from the storage tank at a gas inlet of an ejector, and receiving the increased pressure liquefied natural gas at a liquefied gas inlet of the ejector. The pressure of the increased pressure liquefied gas is used as a motive force to eject combined liquefied natural gas and boil off gas at a pressure greater than that of the boil off gas received at the gas inlet of the ejector. The method additionally includes increasing the pressure of the fluid ejected from the ejector to produce increased pressure ejected fluid.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a liquefied natural gas recondensation system, and more specifically to a liquefied natural gas recondensation system which utilizes pressure from liquefied natural gas as a motive force for liquefying boil off gas.

### 2. Description of the Related Art

Liquefied natural gas (LNG) is a natural gas that may be used in several different industrial capacities, such as use in heating, energy generation, and a transportation fuel. After the natural gas has been harvested, the natural gas may be stored in a storage tank until the natural gas is distributed for consumption. The volume of the natural gas in its liquefied state is much smaller than its volume in its gaseous state. Consequently, the natural gas is typically liquefied for more efficient storage in the storage tank. However, as the LNG resides in the storage tank over a period of time, some of the LNG may boil off to produce a quantity of boil off gas (BOG). Thus, at any given time, the storage tank may include a quantity of LNG and a quantity of BOG contained therein.

Prior to being distributed for consumption, the LNG is typically routed through a vaporizer to convert the LNG into its gaseous form. Thus, the LNG from the storage tank may be extracted and sent to the vaporizer to undergo such phase conversion. However, as noted above, the storage tank may also include a quantity of BOG contained therein, and in the interest of using all of the natural gas from the storage tank, it may be desirable to not only use the LNG, but also the BOG contained in the storage tank. However, the characteristics of the BOG differ from the LNG, and thus, a separate delivery network is typically used to prepare the BOG for use by the consumer. In many conventional delivery networks, the BOG is routed through a compressor to increase the pressure thereof to allow the BOG to be joined with the gaseous LNG produced by the vaporizer.

Although the use of the compressor may allow the BOG to be consumed, operation of the compressor may create inefficiencies in the LNG delivery system. Accordingly, there is a need in the art for an alternative which would allow for use of the BOG in a more efficient manner. Various aspects of the present disclosure address this particular need, as will be discussed in more detail below.

### BRIEF SUMMARY

In accordance with one embodiment of the present disclosure, there is provided a method of recondensing boil off gas (BOG). The method includes receiving liquefied natural gas (LNG) from a storage tank and increasing the pressure of the received LNG to produce increased pressure LNG. The method further includes receiving BOG from the storage tank at a gas inlet of an ejector, and receiving the increased pressure LNG at a liquefied gas inlet of the ejector. The pressure of the increased pressure LNG is used as a motive force to eject combined LNG and BOG at a pressure greater than that of the BOG received at the gas inlet of the ejector. The method additionally includes increasing the pressure of the fluid ejected from the ejector to produce increased pressure ejected fluid.

The method may additionally include mixing the combined LNG and BOG ejected from the ejector to disperse the BOG within the LNG. The BOG may be separated from the LNG ejected from the ejector. The separated BOG may be received at a compressor or may be returned to the ejector.

The pressure of the increased pressure ejected fluid may be increased to a pressure greater than the increased pressure LNG.

The method may also include joining the increased pressure ejected fluid with increased pressure LNG.

The method may further comprise controlling flow of the BOG and increased pressure LNG into the ejector to achieve prescribed ejector output flow characteristics and, more particularly, an output condition wherein all or at least a majority of the output flow (e.g., about 90%) is LNG.

According to another embodiment, there is provided a method of increasing output of LNG from a storage tank. The method includes extracting LNG from the storage tank, and increasing the pressure of the extracted LNG to a first LNG pressure. The method additionally includes extracting BOG from the storage tank and liquefying at least a portion of the extracted BOG by combining the extracted BOG with a portion of the extracted LNG at the first LNG pressure to produce a combined fluid. The method additionally includes increasing the pressure of the combined fluid.

The combined fluid may include BOG and LNG, and the method additionally comprise mixing the combined fluid to disperse the BOG within the LNG. The method may also include separating the BOG from the LNG. The separated BOG may be directed to a compressor.

The method may also include controlling the fluid flow of the combined fluid through the use of a valve.

The pressure of the combined fluid may be increased to a combined fluid pressure greater than the first LNG pressure.

The method may further comprise directing the combined fluid and at least a portion of the extracted LNG to a vaporizer.

The method may additionally include the step of controlling flow of the extracted BOG and extracted LNG to achieve prescribed flow characteristics of the combined fluid.

According to another embodiment, there is provided a gas recondensing system including a first pump placeable in communication with a storage tank configured for storing LNG and BOG. The first pump is configured to receive the LNG from the storage tank at a first inlet pressure and output LNG at a first output pressure greater than the first inlet pressure. An ejector is placeable in communication with the storage tank to receive BOG therefrom at a BOG inlet pressure. The ejector is also placeable in communication with the first pump to receive LNG at the first output pressure. The ejector is configured to combine the received BOG and LNG and utilize the first output pressure as a motive force to output the combined LNG and BOG at an ejector output pressure greater than the BOG inlet pressure. A second pump is placeable in communication with the ejector and is configured to receive fluid output from the ejector and elevate the pressure thereof to a pressure greater than the first output pressure.

The gas recondensing system may additionally include a mixer in communication with the ejector to receive the combined BOG and LNG to disperse the BOG within the LNG. A separator may be in communication with the mixer to receive fluid output from the mixer and separate BOG from the LNG. The separator may include a fluid inlet configured to receive the fluid output from the mixer, a gas outlet and a liquid outlet, with the gas outlet being configured to output separated BOG, and the liquid outlet being configured to output separated LNG.

The gas recondensing system may include a valve disposed fluidly between the ejector and the second pump, with the valve being configured to control the flow of fluid into the second pump to create a desired fluid pressure downstream of the ejector.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic view of a first embodiment of a recondensation system according to the present disclosure;

FIG. 2 is a schematic view of a second embodiment of a recondensation system according to the present disclosure; and

FIG. 3 is a schematic view of a third embodiment of a recondensation system according to the present disclosure.

Common reference numerals are used throughout the drawings and the detailed description to indicate the same elements.

### DETAILED DESCRIPTION

The detailed description set forth below in connection with the appended drawings is intended as a description of certain embodiments of a gas recondensation system and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

The figures show various gas recondensation systems for use in a liquefied natural gas (LNG) delivery network. The gas recondensation system is capable of utilizing pressure from LNG extracted from a storage tank as a motive force for an ejector configured to liquefy boil off gas (BOG) extracted from the storage tank. The incorporation of the ejector into the delivery network provides an alternative mechanism for processing of the BOG into a consumable form, and thus, the need for a conventional compressor for BOG processing may be reduced or eliminated. Consequently, the gas delivery network utilizing the gas recondensation system may be more efficient than conventional gas delivery networks, which may rely solely on a conventional compressor for converting the BOG from the storage tank to useable LNG.

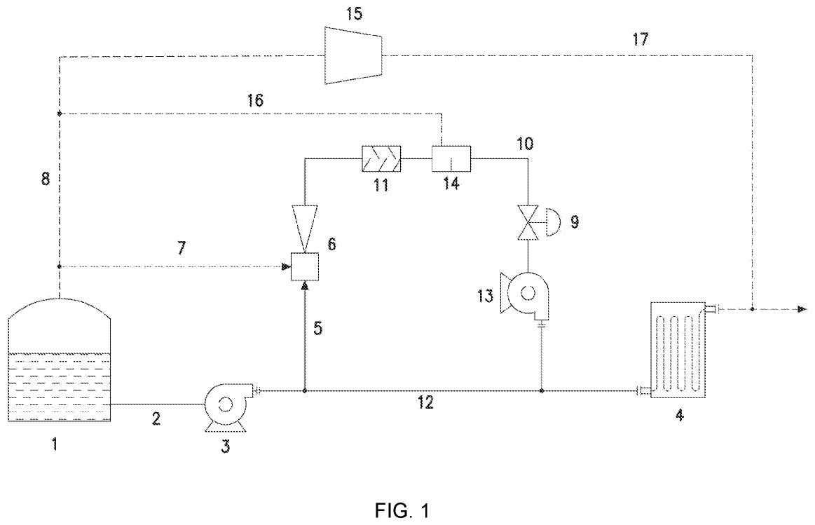

According to one embodiment, and referring now specifically to FIG. 1, the gas recondensing system includes storage tank 1 for storing LNG. The storage tank 1 may include a flat-bottomed tank having a storage volume of approximately 3000 m³, although it is understood that the scope of the present disclosure is not limited thereto. In this regard, any storage tank 1 that may have a different configuration or storage volume may be used without departing from the spirit and scope of the present disclosure. While the LNG is stored in the tank 1, it is contemplated that a portion of the LNG may convert to BOG. Thus, the storage tank 1 may include a combination of LNG as well as BOG.

The gas recondensing system may further include a pipeline 2 and a first pump 3, with the pipeline 2 extending between and fluidly communicating with both the storage tank 1 and the first pump 3 to deliver LNG from the storage tank 1 to the first pump 3. The first pump 3 may include a first pump inlet and a first pump outlet. The LNG enters the first pump 3 via the first pump inlet at a first inlet pressure and exits the first pump 3 via the first pump outlet at a first outlet pressure greater than the first inlet pressure. At least some of the LNG exiting the first pump 3 may flow to a vaporizer 4 via high-pressure pipeline 12 extending therebetween for gasification in preparation for delivery to a consumer.

A diverge pipe 5 may branch off high-pressure pipeline 12 and extend to an ejector 6 to facilitate the delivery of pressurized LNG exiting the first pump outlet of the first pump 3 to an ejector 6. The ejector 6 may also be in communication with a BOG diverge pipe 7, which extends from a BOG line 8 extending from and fluidly communicating with the storage tank 1. The ejector 6 may include an LNG inlet which receives LNG from diverge pipe 5, and a BOG inlet which receives BOG from the BOG diverge pipe 7 at a BOG inlet pressure. The ejector 6 may be configured to combine the received BOG and LNG as the LNG and BOG flow through the ejector 6. The ejector 6 may further be configured to utilize the first output pressure of the LNG flowing through the ejector 6 as a motive force to output a combined fluid comprised of LNG and BOG, with the combined fluid being ejected at an ejector output pressure greater than the BOG inlet pressure. In one embodiment, the entrainment ratio of the ejector 6 is 10:1, and the ejector output pressure is approximately 2.75 bara. However, it is contemplated that the scope of the present disclosure is not limited to a 10:1 entrainment ratio or an ejector output pressure of 2.75 bara.

There are two factors which predominantly govern the conversion of BOG to LNG at the output of the ejector 6. These are: 1) higher pressure (which is regulated by a given by control valve 9 described below); and 2) the cold temperature imparted by LNG introduced into the ejector 6 from diverge line 5. As a result of increased pressure at the output of the ejector 6 and the cold transfer of LNG, the BOG output from the ejector 6 may facilitate phase conversion from BOG to LNG. By converting the BOG to LNG, the converted LNG may be used to increase pressure to a level required by the network for delivery to a consumer. Furthermore, by converting BOG to LNG using the ejector 6, use of a compressor for processing of the BOG prior to consumption may be reduced or eliminated.

As indicated above, the gas recondensing system may additionally include the valve 9 disposed downstream of the ejector 6 and fluidly integrated into a discharge line 10 to control the fluid flow and pressure along the discharge line 10. In particular, the valve 9 may be used to create a desired fluid flow and pressure within the discharge line 10 to facilitate conversion of any BOG ejected from the ejector 6 to LNG based on principles of enthalpy. The valve 9 may be transitioned between closed and open configurations to achieve a desired fluid flow and fluid pressure within the discharge line 10. As the valve 9 is actuated toward or reaches a fully open position, fluid flow along the discharge line 10 may increase, while pressure within the discharge line 10 may decrease. Conversely, when the valve 9 is actuated toward or reaches a fully closed position, fluid flow along the discharge line 10 may decrease or stop, while the pressure within the discharge line 10 may increase. An increase in pressure in the discharge line 10 may facilitate conversion of BOG to LNG. As indicated above, it is also contemplated that the valve 9 may be incrementally adjusted between the closed and open positions to assume various partially open positions to achieve a desired fluid flow and fluid pressure within the discharge line 10. The system may include one or more flow sensors, one or more pressure sensors, and one or more temperature sensors for monitoring flow, pressure, and temperature within the discharge line 10. A digital controller may be in communication with the sensors and the valve 9 for controlling the operational position (e.g., open, closed, partially open) of the valve 9 based on the readings of the sensors. In other words, the operational position of the valve 9 may be based on the detected flow rate, pressure, and/or temperature of ejected fluid in the discharge line 10. Furthermore, by controlling the flow of fluid along the discharge line 10, operation of the valve 9 may also impact the amount of BOG the is introduced into the ejector 6 via BOG diverge pipe 7.

In the embodiment depicted in FIG. 1, the gas recondensing system includes a mixer 11 and a separator 14 disposed on the discharge line 10 between the ejector 6 and the valve 9. The mixer 11 and separator 14 may be included in the gas recondensing system when the fluid that exits the ejector 6 includes a combination of BOG and LNG. The mixer 11 may receive the combined BOG and LNG to disperse the BOG within the LNG to homogenize the mixture for aiding in the conversion of BOG to LNG. The use of the mixer 11 may result in a shortened length of the discharge line 10, as the conversion of BOG to LNG may occur over a shorter span of the discharge line 10 due to the mixing of the fluid. The mixer 11 may include agitators or other structures or devices known in the art for mixing the combined fluid.

The separator 14 may be in communication with the mixer 11 to receive fluid output from the mixer 11 and separate any remaining BOG from the LNG, e.g., BOG which has been emitted from the ejector 6 and passed through the mixer 11, but nonetheless has not converted to LNG. The separator 14 may include a fluid inlet configured to receive the fluid output from the mixer 11, a gas outlet and a liquid outlet, with the gas outlet being configured to output separated BOG, and the liquid outlet being configured to output separated LNG. The separated BOG may be routed to the BOG line 8 via gas return line 16. When reaching the BOG line 8, the BOG from the separator 14 may be combined with BOG extracted from the storage tank 1 and flow toward compressor 15, or may be reintroduced back into the ejector 6 via the diverge pipe 7. The liquid exiting the liquid outlet may flow along discharge line 10 to the valve 9. In one particular implementation, the mixture of LNG and BOG that reaches the separator 14 may include approximately 90% LNG and 10% BOG, although other percentages of LNG and BOG are contemplated.

A second pump 13 may be positioned along and fluidly integrated into the discharge line 10 and may be configured to elevate the pressure of LNG flowing therethrough. In particular, the pressure of the LNG may be elevated to a magnitude greater than that of the first output pressure so as to allow the LNG exiting the second pump 13 to enter the high-pressure LNG line 12 and flow toward vaporizer 4.

The BOG in the BOG line 8, including the BOG from the storage tank 1, and any BOG from the separator 14, may be communicated to a compressor 15, which may convert the BOG to LNG suitable for delivery to a customer via pressurized BOG line 17.

The gas recirculation system shown in FIG. 1 may allow for a more efficient use of the BOG extracted from the storage tank 1. In particular, the pressure of the LNG exiting the first pump 3 may be used to transition the BOG to its liquid state via the ejector 6. The conversion of the BOG to its liquid state allows for reintroduction of the LNG into the conventional delivery path via vaporizer 4, which is much more efficient than operation of the compressor 15 for pressurizing the BOG prior to delivery to a customer. Despite the inefficiencies associated with operating the compressor 15, it is contemplated that the compressor 15 may be included in the system for selective use thereof, as may be desired by the operator of the system. In this regard, operation of the compressor 15 may not be required, but may provide an alternative mechanism for preparing BOG for consumption by a customer. For instance, to the extent that the ejector 6 cannot accept all of the BOG extracted from the storage tank 1, the remaining BOG can be sent to the compressor 15.

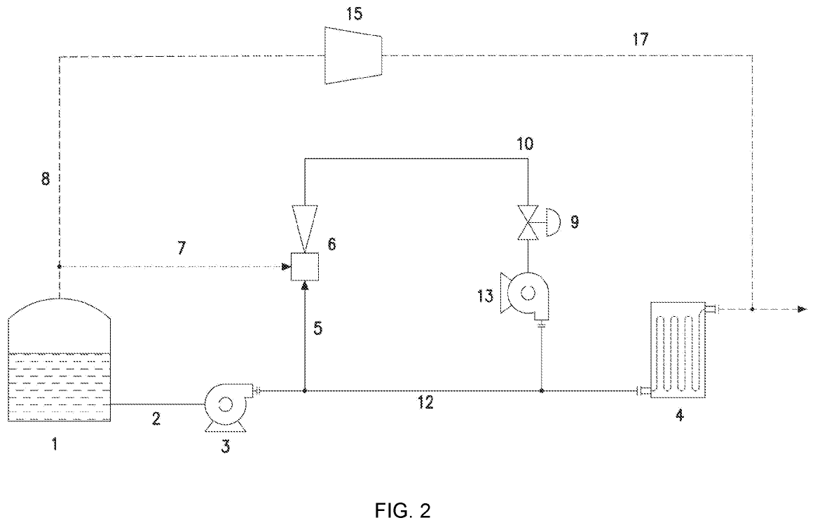

Referring now to FIG. 2, there is shown an alternative embodiment of the gas recirculation system, with the primary distinction being the omission of the mixer 11 and separator 14. In the system shown in FIG. 2, all of the fluid which exits the ejector 6 is either in a liquid state upon exiting the ejector 6 or converts to a liquid state prior to entering the second pump 13. In this regard, the flow conditions (e.g., the pressure) of the fluid within the discharge line 10 may be optimized through the use of the valve 9 to facilitate conversion of any residual BOG present in the discharge line 10 to LNG. Further, the length of the discharge line 10 may be selectively increased as may, in concert with the pressure and flow control resulting from the manipulation of the valve 9, facilitate a complete conversion of any residual BOG present in the discharge line 10 to LNG.

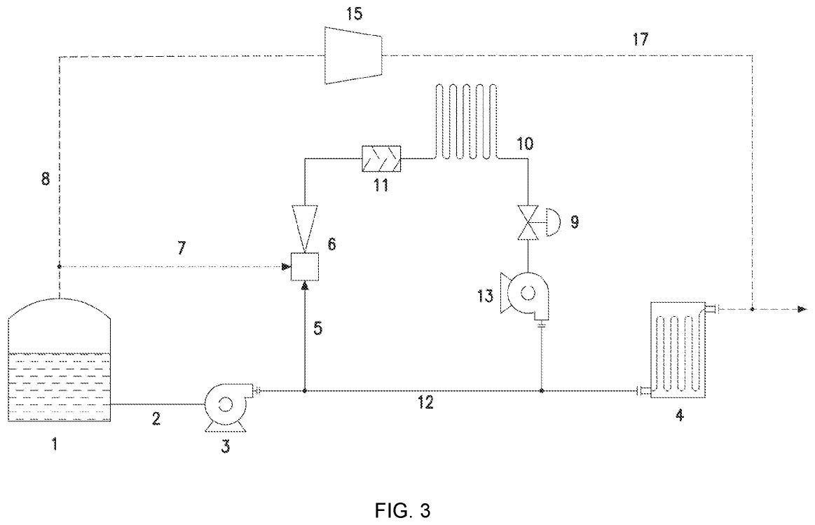

Referring now to FIG. 3, there is depicted yet another alternative embodiment of the gas recirculation system, which differs from the first embodiment shown in FIG. 1 due to the absence of a separator 14, as well as a longer discharge line 10. In the system shown in FIG. 3, the fluid exiting the ejector 6 may include a mixture of BOG and LNG. Thus, the fluid may pass through the mixer 11 to disperse the BOG within the LNG. The mixed fluid may then pass through the lengthened segment of the discharge line 10 to allow the BOG to transition to LNG. The length of the discharge line 10 may be sufficient to allow all of the BOG to convert to LNG prior to entering the second pump 13. Thus, the schematic of FIG. 3 differs from the increased discharge line 10 variant described above in relation to FIG. 2 by virtue of the further inclusion of the mixer 11 to potentially enhance the efficacy of the increased length discharge line 10.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method of recondensing boil off gas, the method comprising the steps of:
receiving liquefied natural gas from a storage tank;
increasing the pressure of the received liquefied natural gas to produce increased pressure liquefied natural gas;
receiving boil off gas from the storage tank at a gas inlet of an ejector;
receiving the increased pressure liquefied natural gas at a liquefied natural gas inlet of the ejector;
utilizing the pressure of the increased pressure liquefied natural gas as a motive force to eject combined liquefied natural gas and boil off gas at a pressure greater than that of the boil off gas received at the gas inlet of the ejector; and
increasing the pressure of the fluid ejected from the ejector to produce increased pressure ejected fluid.

2. The method recited in claim 1, further comprising the step of mixing the combined liquefied natural gas and boil off gas ejected from the ejector to disperse the boil off gas within the liquefied natural gas.

3. The method recited in claim 2, further comprising the step of separating boil off gas from the liquefied natural gas ejected from the ejector.

4. The method recited in claim 3, further comprising the step of receiving the separated boil off gas at one of a compressor and the ejector.

5. The method recited in claim 1, wherein the pressure of the increased pressure ejected fluid is increased to a pressure greater than the increased pressure liquefied natural gas.

6. The method recited in claim 1, further comprising the step of joining the increased pressure ejected fluid with increased pressure liquefied natural gas.

7. The method recited in claim 1, further comprising the step of controlling flow of the boil off gas and increased pressure liquefied natural gas into the ejector to achieve prescribed ejector output flow characteristics.

8. A method of increasing output of liquefied natural gas from a storage tank, the method comprising the steps of:
extracting liquefied natural gas from the storage tank;
increasing the pressure of the extracted liquefied natural gas to a first liquefied natural gas pressure;
extracting boil off gas from the storage tank;
liquefying at least a portion of the extracted boil off gas by combining the extracted boil off gas with a portion of the extracted liquefied natural gas at the first liquefied natural gas pressure to produce a combined fluid; and
increasing the pressure of the combined fluid.

9. The method recited in claim 8, wherein the combined fluid includes boil off gas and liquefied natural gas, the method further comprising the step of mixing the combined fluid to disperse the boil off gas within the liquefied natural gas.

10. The method recited in claim 9, further comprising the step of separating the boil off gas from the liquefied natural gas.

11. The method recited in claim 10, further comprising the step of directing the separated boil off gas to a compressor.

12. The method recited in claim 8, further comprising the step of controlling the fluid flow of the combined fluid through the use of a valve.

13. The method recited in claim 8, wherein the pressure of the combined fluid is increased to a combined fluid pressure greater than the first liquefied natural gas pressure.

14. The method recited in claim 8, further comprising directing the combined fluid and at least a portion of the extracted liquefied natural gas to a vaporizer.

15. The method recited in claim 8, further comprising the step of controlling flow of the extracted boil off gas and extracted liquefied natural to achieve prescribed flow characteristics of the combined fluid.

16. A gas recondensing system comprising:
a first pump disposable in communication with a storage tank configured for storing liquefied natural gas and boil off gas, the first pump being configured to receive the liquefied natural gas from the storage tank at a first inlet pressure and output liquefied natural gas at a first output pressure greater than the first inlet pressure;
an ejector disposable in communication with the storage tank to receive boil off gas therefrom at a boil off gas inlet pressure, the ejector further being disposable in communication with the first pump to receive liquefied natural gas at the first output pressure, the ejector being configured to combine the received boil off gas and liquefied natural gas and utilize the first output pressure as a motive force to output the combined liquefied natural gas and boil off gas at an ejector output pressure greater than the boil off gas inlet pressure; and
a second pump disposable in communication with the ejector and configured to receive fluid output from the ejector and elevate the pressure thereof to a pressure greater than the first output pressure.

17. The gas recondensing system recited in claim 16, further comprising a mixer in communication with the ejector to receive the combined boil off gas and liquefied natural gas to disperse the boil off gas within the liquefied gas.

18. The gas recondensing system recited in claim 17, further comprising a separator in communication with the mixer to receive fluid output from the mixer and separate boil off gas from the liquefied natural gas.

19. The gas recondensing system recited in claim 18, wherein the separator includes a fluid inlet configured to receive the fluid output from the mixer, a gas outlet and a liquid outlet, the gas outlet being configured to output separated boil off gas, and the liquid outlet being configured to output separate liquefied natural gas.

20. The gas recondensing system recited in claim 16, further comprising a valve disposed fluidly between the ejector and the second pump, the valve being configured to control the flow of fluid into the second pump to create a desired fluid pressure downstream of the ejector.
